(19) United States
(12) Patent Application Publication
(10) Pub. No.: US 2018/0361927 A1
(43) Pub. Date: Dec. 20, 2018

(54) AUTOMOBILE BABY REMINDER

(71) Applicant: Sharon Debowski, Stanhope, NJ (US)

(72) Inventor: Sharon Debowski, Stanhope, NJ (US)

(21) Appl. No.: 15/624,376

(22) Filed: Jun. 15, 2017

(51) Int. Cl. B60Q 9/00; G08B 21/02

(52) U.S. Cl. CPC B60Q 9/00; G08B 21/02

(57) ABSTRACT

A reminder device has a support base adapted for attachment to one of a vehicle interior, a vehicle key, and a vehicle keyless remote access device. The reminder device also includes means for providing at least one of a visual and an audible prompt to a driver or other user to check for the presence of an infant, baby, or toddler on board the vehicle in order to prevent the infant, baby, or toddler from being left behind in a car or other vehicle.

### BACKGROUND OF THE INVENTION

Too often in recent years, there have been tragic incidents where babies, infants, or toddlers have perished because they were left behind in a locked car in hot weather. The need remains for a warning or reminder device to prompt a vehicle's driver or other responsible adult to check the vehicle for the presence of an infant, baby, or toddler in order to prevent the infant, baby, or toddler from being left behind in a hot, locked car.

### SUMMARY OF THE INVENTION

The present invention is directed to a reminder device to prompt a vehicle's driver or other responsible adult to check the vehicle for the presence of an infant, baby, or toddler in order to prevent the infant, baby, or toddler from being left behind in a car or other vehicle.

Embodiments of the present invention comprise an audio module that include at least some components of known audio modules such as disclosed, for example, in U.S. Pat. Nos. 3,998,045, 7,755,471 B2, and 8,634,278 B1 and in U.S. Patent Application Publication 2014/0192626 A1, each of which is incorporated herein in their entirety by reference.

Accordingly, it is an aspect of the present invention to provide a reminder device for use in automotive applications in relation to an automobile or other vehicle, the reminder device comprising:

a support base adapted for attachment to one of a vehicle interior, a vehicle key, and a vehicle keyless remote access device; and

means for providing at least one of a visual and an audible prompt to a user to check for the presence of an infant, baby, or toddler on board the vehicle in order to prevent the infant, baby, or toddler from being left behind in a car or other vehicle, the means for providing at least one of a visual and an audible prompt being supported by the support base.

It is another aspect of the present invention to provide a reminder device as set forth above, wherein the means for providing at least one of a visual and an audible prompt provides a visual prompt and comprises a readily visible written statement that reminds the user to check the vehicle for the presence of an infant, baby, or toddler.

It is yet another aspect of the present invention to provide a reminder device incorporating any of the above-described aspects of the present invention, wherein the means for providing at least one of a visual and an audible prompt provides a visual prompt and comprises a transparent pocket for holding a picture of an infant, baby, or toddler.

It is yet another aspect of the present invention to provide a reminder device incorporating any of the above-described aspects of the present invention, wherein the means for providing at least one of a visual and an audible prompt provides an audible prompt and comprises a device selected from a bell, a rattle, and a chime attached to the support base, whereby the bell, rattle, or chime automatically generates sounds that direct the user's attention to the reminder device when the reminder device is attached to the door of an automobile and the door is opened.

It is yet another aspect of the present invention to provide a reminder device incorporating any of the above-described aspects of the present invention, wherein the means for providing at least one of a visual and an audible prompt also provides a visual prompt and comprises a readily visible written statement that reminds the user to check the vehicle for the presence of an infant, baby, or toddler.

It is yet another aspect of the present invention to provide a reminder device incorporating any of the above-described aspects of the present invention, wherein the means for providing at least one of a visual and an audible prompt further comprises a transparent pocket for holding a picture of an infant, baby, or toddler.

It is yet another aspect of the present invention to provide a reminder device incorporating any of the above-described aspects of the present invention, wherein the support base comprises a rectangular sheet of flexible material having a hole in each corner.

It is yet another aspect of the present invention to provide a reminder device incorporating any of the above-described aspects of the present invention, wherein the reminder device further comprises a pair of hooks provided with suction cups that engage respective holes at the top corners of the support base to attach the reminder device to an interior surface of a vehicle door.

It is yet another aspect of the present invention to provide a reminder device incorporating any of the above-described aspects of the present invention, wherein the support base comprises a rectangular sheet of flexible material having a top edge and a first portion of a hook and loop fastener provided in a strip form on the backside of the sheet near the top edge of the sheet, and

wherein the reminder device further comprises a second portion of a hook and loop fastener provided in a strip form and adapted for attachment to an interior surface of a vehicle door using adhesive material applied to the backside of the second portion of a hook and loop fastener to thereby attach the reminder device to the interior surface of the vehicle door.

It is yet another aspect of the present invention to provide a reminder device incorporating any of the above-described aspects of the present invention, wherein the support base is adapted for attachment to a key used for access or ignition of a vehicle, wherein the key has a head and a blade, and wherein the support base is adapted for attachment to the head of the key used for access or ignition of the vehicle.

It is yet another aspect of the present invention to provide a reminder device incorporating any of the above-described aspects of the present invention, wherein the means for providing at least one of a visual and an audible prompt further comprises a readily visible written statement that reminds the user to check the vehicle for the presence of an infant, baby, or toddler.

It is yet another aspect of the present invention to provide a reminder device incorporating any of the above-described aspects of the present invention, wherein the support base is adapted for attachment to the head of the key using adhesive material applied to one side of the support base near an edge of the support base such that the blade of the key is clear of the support base and the reminder device will not interfere with the normal operation of the key.

It is yet another aspect of the present invention to provide a reminder device incorporating any of the above-described aspects of the present invention, wherein the support base is in the form of a rigid, transparent, rectangular, and flat plate of plastic or polymeric material.

It is yet another aspect of the present invention to provide a reminder device incorporating any of the above-described aspects of the present invention, wherein the means for providing at least one of a visual and an audible prompt provides an audible prompt comprising a recorded audio message or sounds that prompt the user to check for the presence of an infant, baby, or toddler on board the vehicle.

It is yet another aspect of the present invention to provide a reminder device incorporating any of the above-described aspects of the present invention, wherein the means for providing at least one of a visual and an audible prompt provides an audible prompt and comprises an audio module supported by the support base, the audio module being adapted to store and playback at least one audio file containing the recorded audio message or sounds that prompt the user to check the vehicle for the presence of an infant, baby, or toddler.

It is yet another aspect of the present invention to provide a reminder device incorporating any of the above-described aspects of the present invention, wherein the audio module comprises:

a speaker;

an audio chip with on-board memory for storing the audio file and communicating with the speaker so as to be capable of providing audio signals to the speaker for playback of the recorded audio message or sounds contained in the audio file;

a battery for powering the audio module; and

a pressure switch communicating with the audio chip such that the recorded audio message or sounds that prompt the user to check for the presence of an infant, baby, or toddler on board the vehicle are played back through the speaker when the pressure switch is pressed.

It is yet another aspect of the present invention to provide a reminder device incorporating any of the above-described aspects of the present invention, wherein the audio module further comprises:

a housing containing the speaker, the audio chip, and the battery, wherein the pressure switch is located external to the housing.

It is yet another aspect of the present invention to provide a reminder device incorporating any of the above-described aspects of the present invention, wherein the audio file contains a recorded audio message that prompts the user to check for the presence of an infant, baby, or toddler on board the vehicle.

It is yet another aspect of the present invention to provide a reminder device incorporating any of the above-described aspects of the present invention, wherein the audio module is pressure activated and includes a pressure detecting portion, wherein the support base is in the form of a pocket made of flexible material, the pocket having a back side, the audio module being contained within the pocket, the pocket being adapted for attachment to a vehicle keyless remote access device having a backside and a door locking switch, the pocket being adapted for attachment to the backside of the vehicle keyless remote access device using adhesive material applied to the backside of the pocket to thereby attach the reminder device to the backside of the vehicle keyless remote access device at a location such that at least the pressure portion of the audio module is located behind the door locking switch of the vehicle keyless remote access device such that the audio module is automatically activated to play back the recorded audio message or sounds that prompt the user to check for the presence of an infant, baby, or toddler on board the vehicle when the user presses the door locking switch of the vehicle keyless remote access device.

It is yet another aspect of the present invention to provide a reminder device incorporating any of the above-described aspects of the present invention, wherein the audio module is pressure activated and includes a pressure detecting portion, wherein the support base is in the form of a sleeve made of flexible material and being provided with a pocket, the audio module being contained within the pocket, the sleeve being adapted for placement around a door handle of a vehicle to thereby attach the reminder device to the door handle of the vehicle and thereby attach the reminder device to the vehicle interior, the door handle having a backside, the pocket being positioned relative to the sleeve so as to allow at least the pressure portion of the audio module to be located on the backside of the vehicle door handle such that the audio module is automatically activated to play back the recorded audio message or sounds that prompt the user to check for the presence of an infant, baby, or toddler on board the vehicle when the user pulls the vehicle door handle to open the vehicle door.

These and other aspects and advantages of the present invention will be further elucidated by the following Detailed Description, drawing figures, and Claims.

### BRIEF DESCRIPTION OF THE DRAWING FIGURES

The attached drawings show embodiments of the invention in the several views.

FIGS. 1-3 show a first embodiment of the present invention that uses bells, rattles, or chimes or the like to get a user's attention and direct them to a statement that prompts them to check on any infant or toddler in the car and/or to the picture of the infant or toddler.

FIG. 4 shows the embodiment of FIGS. 1-3, that is attached to the interior of the car by a hook and loop fastener rather than the hooks and suction cups of FIGS. 1-3.

FIGS. 5-7 show another embodiment of the present invention that is intended for attachment to the head of a car key using adhesive material.

FIGS. 8-14 show another embodiment of the present invention that uses an electronic audio module to play back a message and/or warning sounds and is intended for attachment to a vehicle keyless remote access device using adhesive material.

FIGS. 15-17 show another embodiment of the present invention that uses an electronic audio module to play back a message and/or warning sounds and has a sleeve that is intended for placement around the door handle of a vehicle.

### DETAILED DESCRIPTION

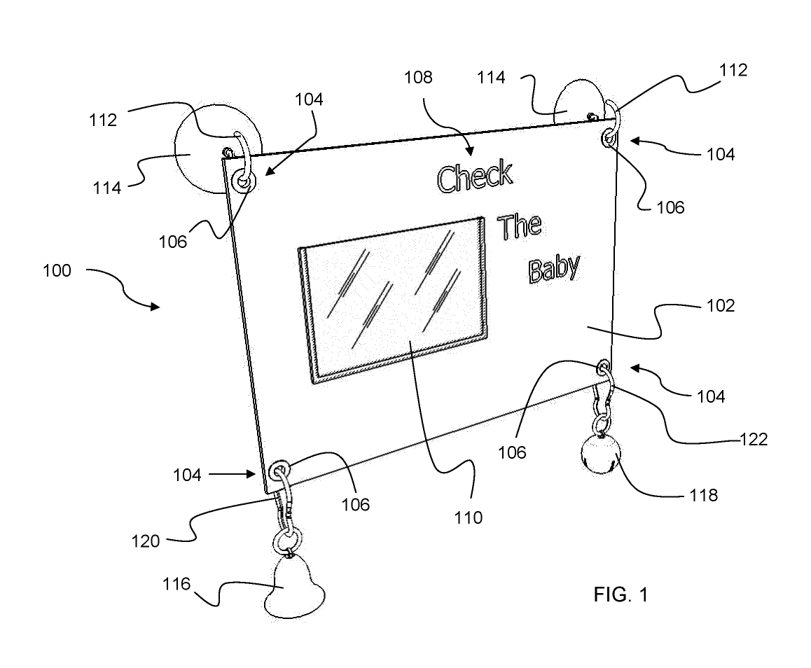

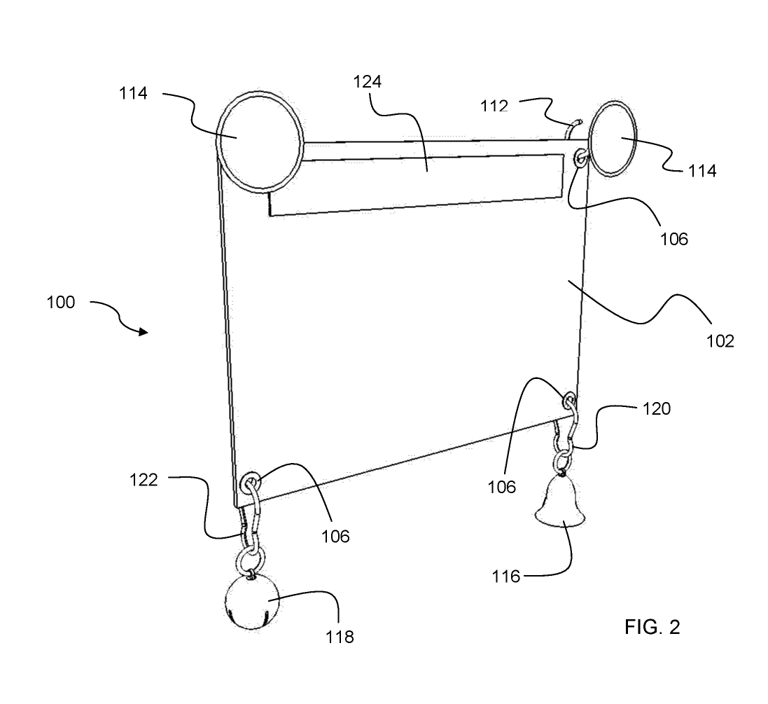

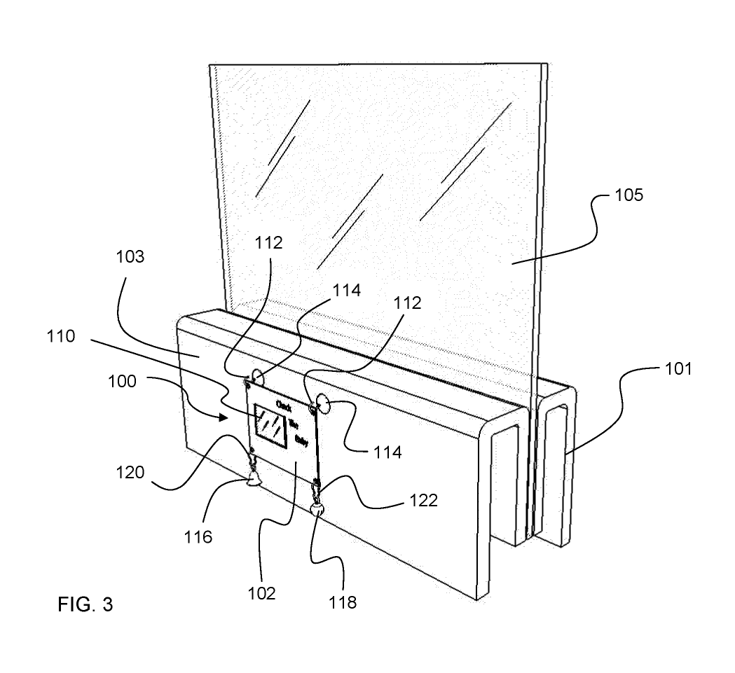

Referring to FIGS. 1-3, a first embodiment 100 of the present invention can be seen. The reminder device 100 includes a support base 102 and means for providing at least one of a visual and an audible prompt to a user to check for the presence of an infant, baby, or toddler on board the vehicle in order to prevent the infant, baby, or toddler from being left behind in a car or other vehicle. The support base 102 includes a rectangular sheet of flexible material having a hole 104 in each corner. Each hole 104 is preferably reinforced with a grommet 106. On the front side of the sheet 102, a statement 108 with the words “Check the Baby” is printed. The statement 108 is an example of corresponding structure encompassed within the means for providing at least one of a visual and an audible prompt to a user to check for the presence of an infant, baby, or toddler on board the vehicle in order to prevent the infant, baby, or toddler from being left behind in a car or other vehicle.

A transparent pocket 110 may also be provided on the front side of the sheet 102. The transparent pocket is adapted for holding a picture of an infant, baby, or toddler to provide yet another visual prompt to remind the user, which may include the driver of the vehicle or other responsible adult or any other person making use of the invention, to check the vehicle for the presence of an infant, baby, or toddler in order to prevent the infant, baby, or toddler from being left behind in the vehicle. The transparent pocket 110 is also an example of corresponding structure encompassed within the means for providing at least one of a visual and an audible prompt to a user to check for the presence of an infant, baby, or toddler on board the vehicle in order to prevent the infant, baby, or toddler from being left behind in a car or other vehicle. Preferably the picture would be of the particular infant or toddler that would usually be transported in the particular vehicle.

The reminder device 100 also includes a pair of hooks 112 provided with suction cups 114 that engage respective holes 104 at the top corners of the support base 102 to attach the reminder device 100 to an interior surface of a vehicle door 101 such as, for example, the interior door panel 103, or the window glass 105.

The reminder device may also include a bell 116 and/or a rattle or chime 118 that automatically generates sounds that direct the user's attention to the reminder device 100 when the reminder device 100 is attached to the door 101 of an automobile and the door is opened or closed. The bell 116 and the rattle or chime 118 are also examples of corresponding structure encompassed within the means for providing at least one of a visual and an audible prompt to a user to check for the presence of an infant, baby, or toddler on board the vehicle in order to prevent the infant, baby, or toddler from being left behind in a car or other vehicle. In the illustrated example, the bell 116 and the rattle or chime 118 are connected to the sheet 102 by respective snap hooks 120 and 122, which engage respective holes 104 near the bottom edge of the sheet 102.

The rectangular sheet of flexible material 102 may have a first portion of a hook and loop fastener, which is preferably in the form of a strip, provided on the backside of the sheet 102 near the top edge of the sheet 102. The hook and loop fastener portion 124 can provide an alternative way for fixing the reminder device 100 to the interior of the car door 101.

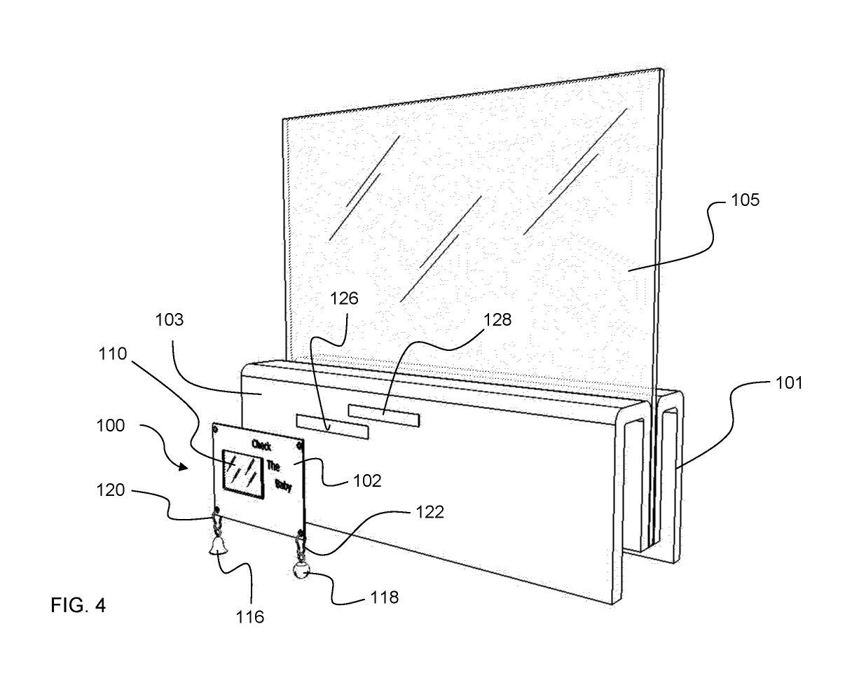

Referring to FIG. 4, the reminder device 100 may also include a second portion of a hook and loop fastener 126, which is also in strip form and of the complementary type that is capable of engagement to the first hook and loop fastener portion 124. The second portion of a hook and loop fastener 126 is adapted for attachment to an interior surface of a vehicle door 101 using adhesive material 128 applied to the backside of the second portion of a hook and loop fastener 126 to thereby attach the second portion of a hook and loop fastener 126 to an interior surface of the vehicle door 101. The reminder device 100 can then be attached to the interior surface of the vehicle door by engaging the first hook and loop fastener portion 124 to the second portion of a hook and loop fastener 126. In the illustrated embodiment, the adhesive material 128 is a strip of double sided adhesive tape. The tape 128 may be pre-applied to the back of the second portion of a hook and loop fastener 126 and the exposed side of the adhesive tape 128 may be protected by a release liner that is removed to prepare the second portion of a hook and loop fastener 126 for immediate use. Alternatively, adhesive may be directly applied to the back of the second portion of a hook and loop fastener 126 and protected by a release liner until the time the second portion of a hook and loop fastener 126 is to be applied to an interior surface of the car door 101.

The support base 102 may be a rectangular sheet of cloth, vinyl, canvas or leather material measuring 4×2, or 3×4, or 4×6, or 3×5, or 5×7 (measurements are in inches) with holes reinforced by grommets in the four corners of the rectangular sheet 102. Grommets 106 at top of sheet 102 are for two hooks 112 with section cups 114 to hold the sheet 102 to the car window 105 or just above the door handle. Grommets 106 at bottom of sheet 102 are for holding the bell 116 or baby rattle 118 in each of the lower corners of the sheet 102. The words “Check the Baby” may be silkscreened onto the front of the sheet 102.

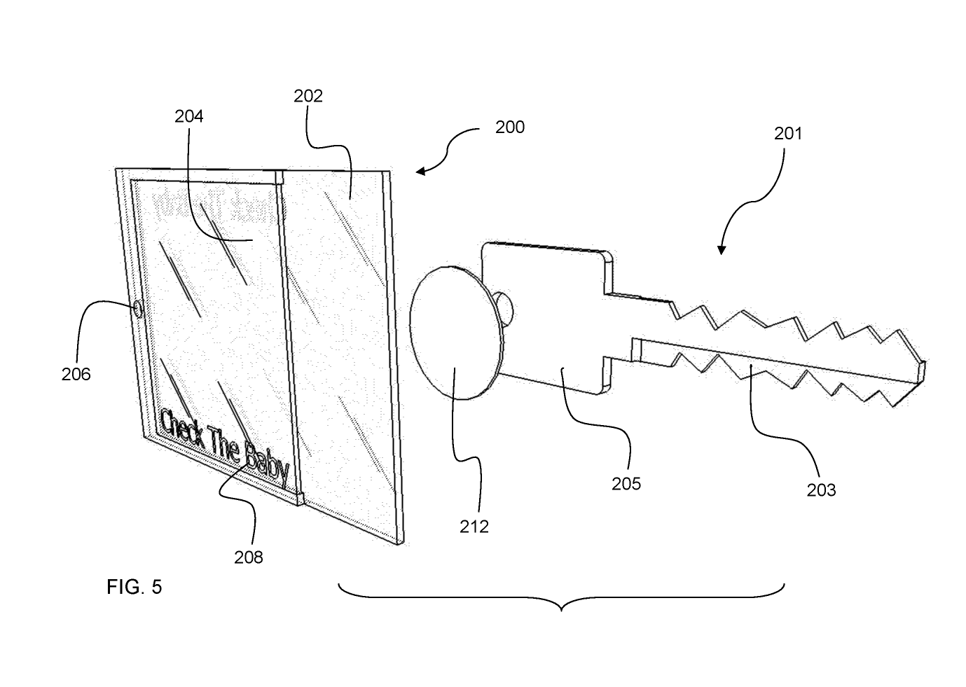

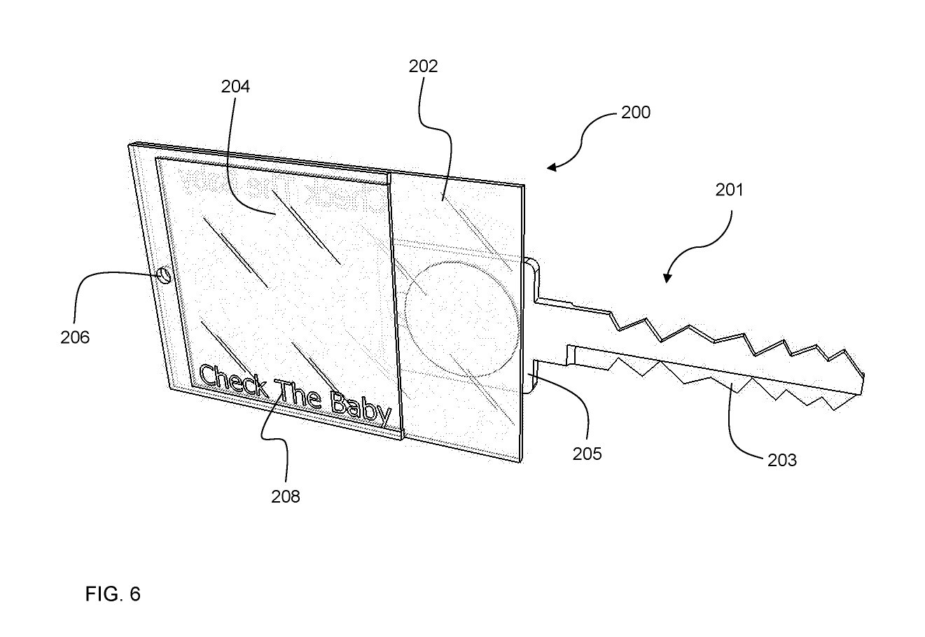

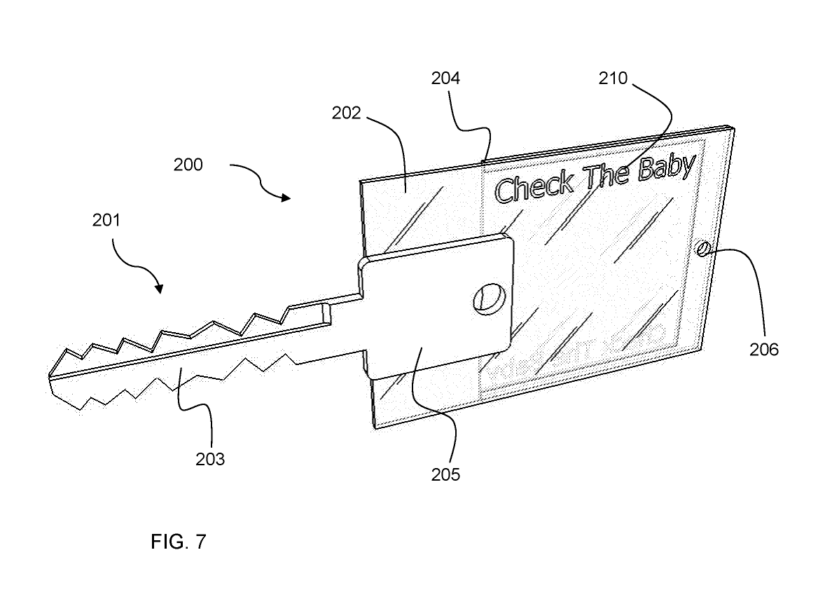

Referring to FIGS. 5-7, a second embodiment 200 of the reminder device of the present invention can be seen. The reminder device 200 includes a support base 202 and a transparent pocket 204. The support base 202 is adapted for attachment to a key 201, which may be car door key or an ignition key. The key 201 typically has a head 205 and a blade 203. The support base 202 is adapted for attachment to the head 205 of the key 201.

Readily visible written statements 208 and 210 that remind the user to check the vehicle for the presence of an infant, baby, or toddler are provided on the front and back of the reminder device 200. The statements 208 and 210 contain the words “Check the Baby” and may be printed on the front and back of the reminder device 200. The statements 208 and 210 are examples of corresponding structure encompassed within the means for providing at least one of a visual and an audible prompt to a user to check for the presence of an infant, baby, or toddler on board the vehicle in order to prevent the infant, baby, or toddler from being left behind in a car or other vehicle.

The transparent pocket 204 may be provided on the front side of the support base 202. The transparent pocket 204 is adapted for holding a picture of an infant, baby, or toddler to provide yet another visual prompt to remind the user to check the vehicle for the presence of an infant, baby, or toddler in order to prevent the infant, baby, or toddler from being left behind in the vehicle. The transparent pocket 204 is also an example of corresponding structure encompassed within the means for providing at least one of a visual and an audible prompt to a user to check the vehicle for the presence of an infant, baby, or toddler in order to prevent the infant, baby, or toddler from being left behind in a car or other vehicle.

The support base 202 is adapted for attachment to the head 205 of the key 201 using adhesive material 212 applied to one side of the support base 202 near an edge of the support base 202 such that the blade 203 of the key 201 is clear of the support base 202 and the reminder device 200 will not interfere with the normal operation of the key 201. In the illustrated example, the support base 202 is in the form of a rigid, transparent, rectangular, and flat plate of plastic or polymeric material. The reminder device 200 is provided with a hole 206 so that the assembly including the reminder device 200 and the key 201 can be placed on a key ring in the same manner as any other key. In the illustrated example, hole 206 passes through both the support base 202 and the transparent pocket 204 near the edge of the support base 202 that is farthest from the edge of the support base 202 that is nearest the location of the attachment between the key 201 and the support base 202.

The support base 202 may be made of a hard clear plastic measuring 2 inches high×3 inches wide. The reminder device 200 may also be attached to a vehicle keyless remote access device 301 instead of the key 201. In the illustrated embodiment, the adhesive material 212 is a disc of double sided adhesive tape. The tape 212 may be pre-applied to the back of the support base 202 and the exposed side of the adhesive tape 212 may be protected by a release liner that is removed to prepare the reminder device 200 for immediate attachment to a key 201. Alternatively, adhesive may be directly applied to the back of the support base 202 and protected by a release liner until the time the reminder device 200 is to be attached to a key 201. As an alternative, adhesively attached hook and loop fastener portions may be applied to the key head 205 and the support base 202.

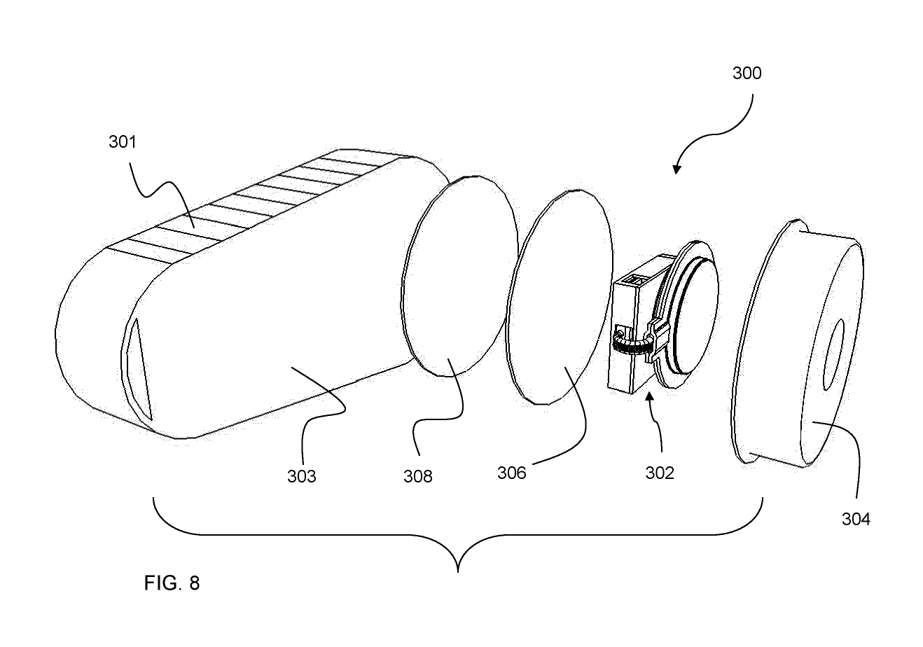

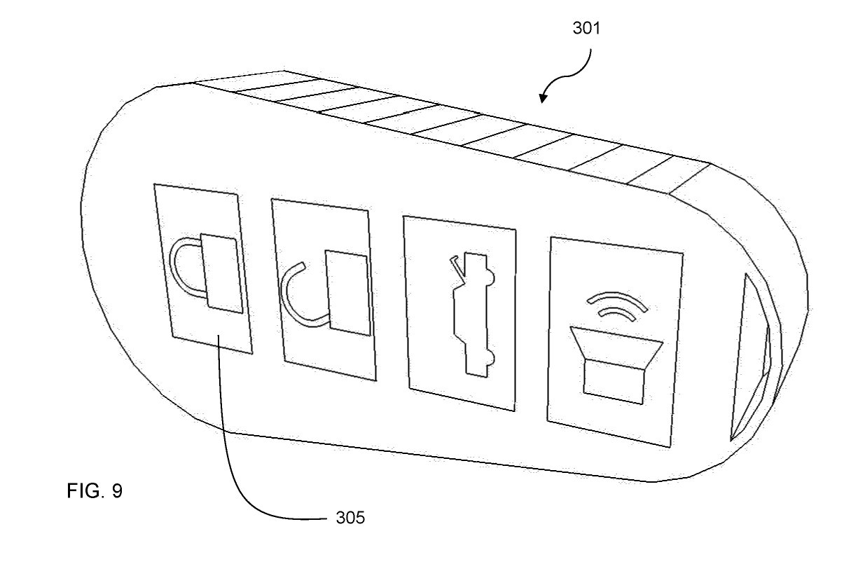

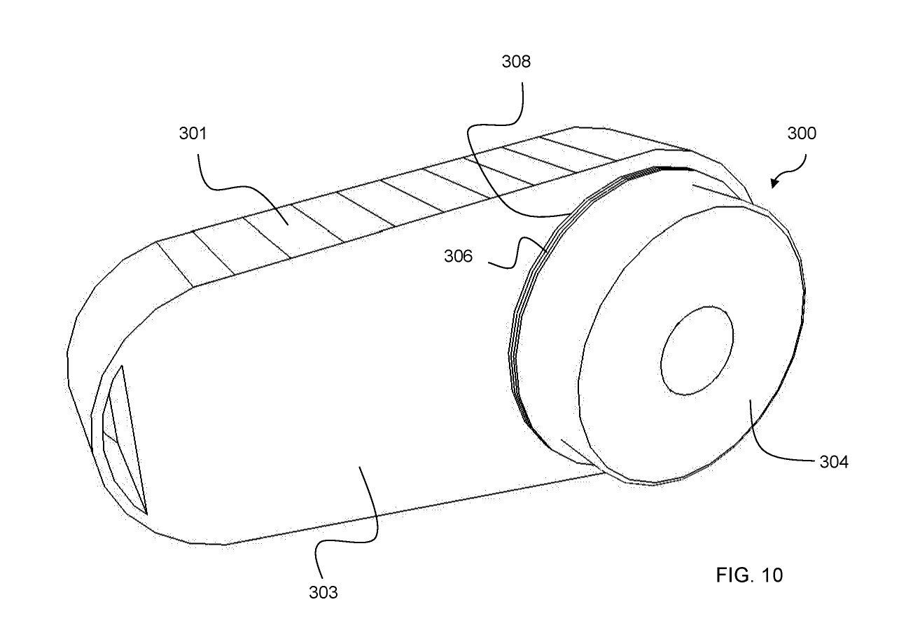

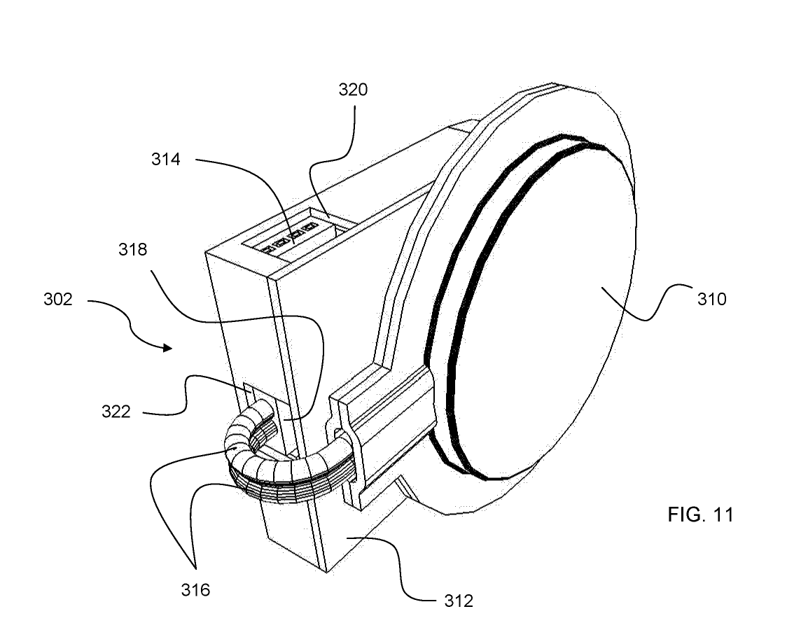

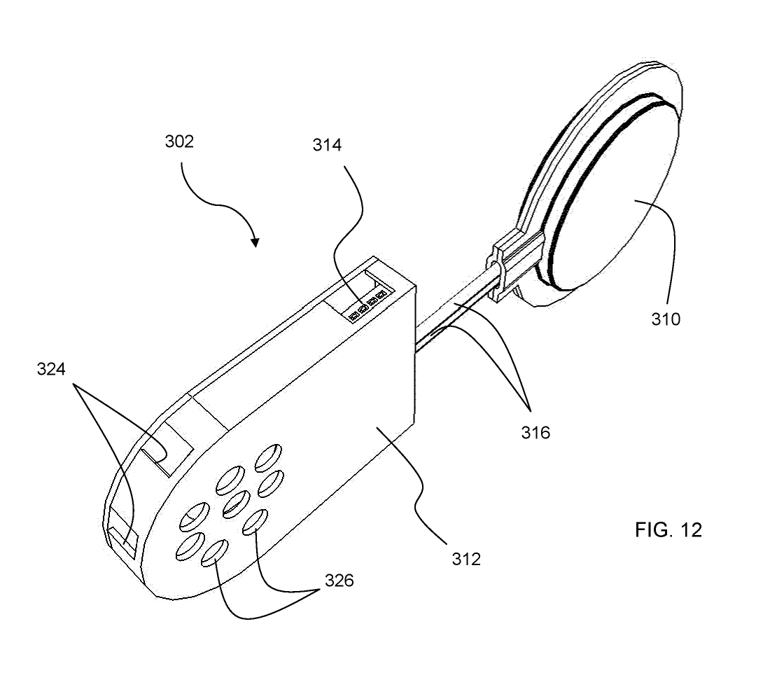

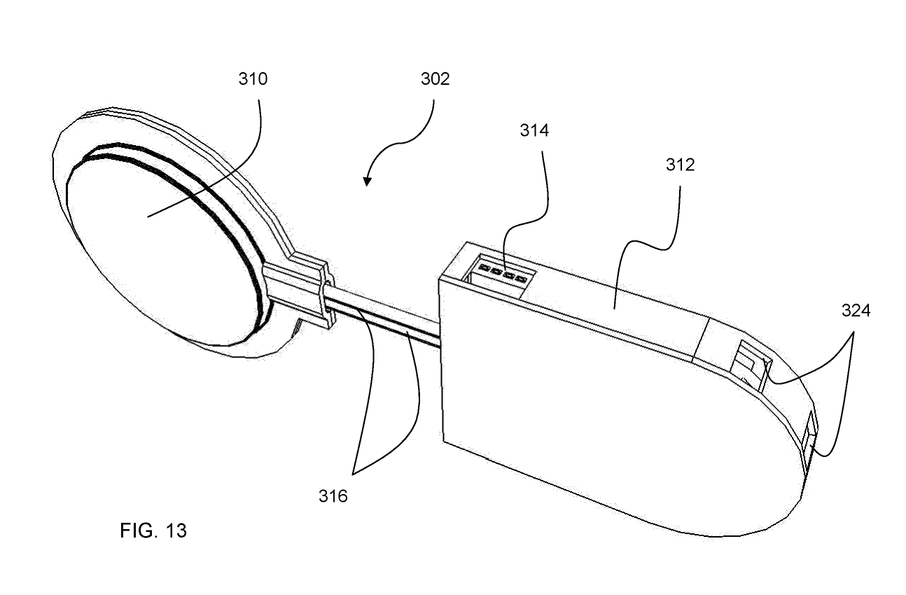

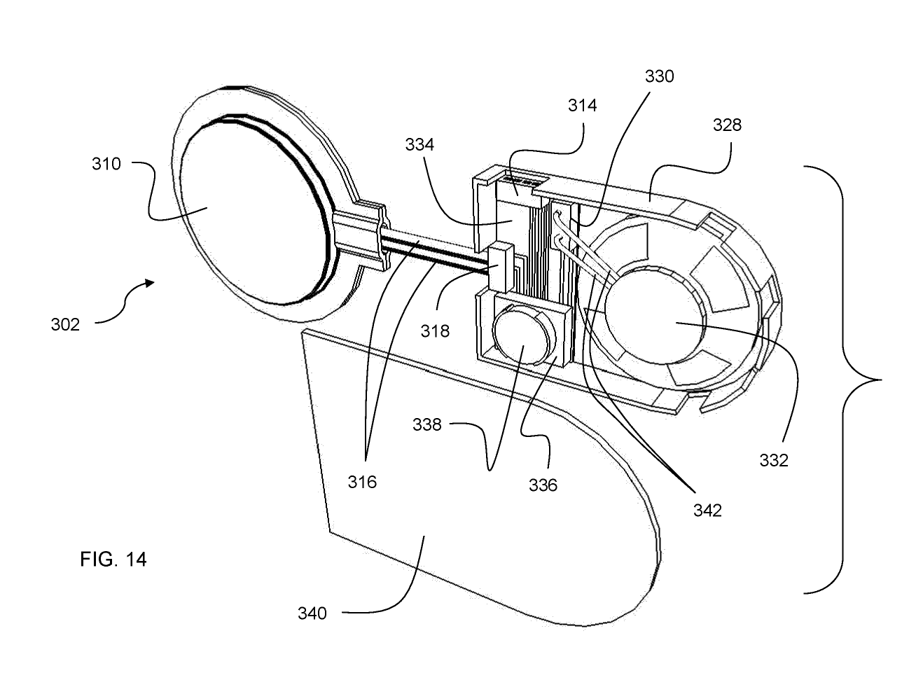

Referring to FIGS. 8-14, a third embodiment 300 of the present invention can be seen. The reminder device 300 includes means for providing at least one of a visual and an audible prompt that provides an audible prompt comprising a recorded audio message and/or sounds that prompt the user to check for the presence of an infant, baby, or toddler on board the vehicle. The means for providing at least one of a visual and an audible prompt comprises an audio module 302 supported by the support base. The audio module 302 is adapted to store and playback at least one audio file containing the recorded audio message or sounds that prompt the user to check the vehicle for the presence of an infant, baby, or toddler. The audio module 302 can be of the micro-miniature variety and can be powered by a battery 338 that may be of coin cell or button cell types.

The audio module 302 includes a housing 312, a speaker 332, a pressure switch 310, and associated electronics that are carried on a printed circuit board 334 housed inside the audio module housing 312. The printed circuit board 334 carries an audio chip 336, a battery 338, a connector 318 for the pressure switch, a connector 330 for the speaker 332, and an input port 314 for at least loading audio files into the on-board memory of the audio chip 336. The printed circuit board 334 also carries all the necessary connections, in the form of conductor lines and battery terminal contacts (not shown in detail), for interfacing the various devices carried on the printed circuit board 334. The pressure switch 310 is connected to the connector 318 by wires 316. The speaker 332 is connected to the connector 330 by wires 342.

The housing 312 has openings 324 and 326 that allow the speaker sounds to be heard more clearly. The housing 312 has openings 320 and 322 that allow access to the input port 314 and the connector 318 for the pressure switch, respectively. The housing 312 includes a housing base 328 that supports the printed circuit board 334 and the speaker 332. The housing 312 also includes a cover or lid 340 that provides a protective closure for the housing base 328.

The audio chip 336 has on-board memory for storing audio files containing the recorded audio message and/or warning, attention, and/or alarm sounds. The audio chip 336 communicates with the speaker 332 so as to be capable of providing audio signals to the speaker 332 for playback of the recorded audio message and/or sounds contained in the audio files. The battery 338 powers the audio module. The pressure switch 310 communicates with the audio chip 336 such that the recorded audio message or sounds that prompt the user to check the vehicle for the presence of an infant, baby, or toddler are played back through the speaker when the pressure switch is pressed.

The housing 312 contains the speaker 332, the audio chip 336, and the battery 338. The pressure switch 310 is located external to the housing 312. The one or more audio files may contain a recorded audio message that prompts the user to check the vehicle for the presence of an infant, baby, or toddler.

The audio module 302 is pressure activated and includes a pressure detecting portion, which in the illustrated example would correspond to the pressure switch 310. In this example, the support base is in the form of a circular pocket made of flexible material. The pocket is made of a top cover 304 and a bottom cover 306 that are joined together, for example by sewing, heat fusion, or adhesive, along their respective edges. The pocket has a back side that corresponds to the back side of the bottom cover 306. The audio module 302 is contained within the pocket. The pocket is adapted for attachment to a vehicle keyless remote access device 301 having a back side 303 and a door locking switch 305. The pocket is adapted for attachment to the backside of the vehicle keyless remote access device 301 using adhesive material 308 applied to the back side of the pocket to thereby attach the reminder device 300 to the back side of the vehicle keyless remote access device 301. The reminder device 300 to the back side of the vehicle keyless remote access device 301 at a location such that at least the pressure portion 310 of the audio module 302 is located behind the door locking switch 305 of the vehicle keyless remote access device 301 such that the audio module 302 is automatically activated to play back the recorded audio message or sounds that prompt the user to check for the presence of an infant, baby, or toddler on board the vehicle when the user presses the door locking switch 305 of the vehicle keyless remote access device 301.

The audio module 302 and other electronic devices capable of playing back audio and/or visual messages and/or sounds are yet more examples of corresponding structure encompassed within the means for providing at least one of a visual and an audible prompt to a user to check for the presence of an infant, baby, or toddler on board the vehicle in order to prevent the infant, baby, or toddler from being left behind in a car or other vehicle.

In the illustrated embodiment, the adhesive material 308 is a disc of double sided adhesive tape. The tape 308 may be pre-applied to the back of the support base, which in this case is the pocket formed by the top cover 304 and the bottom cover 306, and the exposed side of the adhesive tape 308 may be protected by a release liner that is removed to prepare the reminder device 300 for immediate attachment to the vehicle keyless remote access device 301. Alternatively, adhesive may be directly applied to the back of the support base, which corresponds to the back side of the bottom cover 306, and protected by a release liner until the time the reminder device 300 is to be attached to the vehicle keyless remote access device 301. As an alternative, adhesively attached hook and loop fastener portions may be applied to the back of the vehicle keyless remote access device 301 and the back side of the bottom cover 306 that forms part of the pocket or support base.

As an alternative embodiment, the functions of the reminder device 300 can be integrated into a vehicle keyless remote access device that has been suitably modified. In such a case the housing of the vehicle keyless remote access device would constitute the support base.

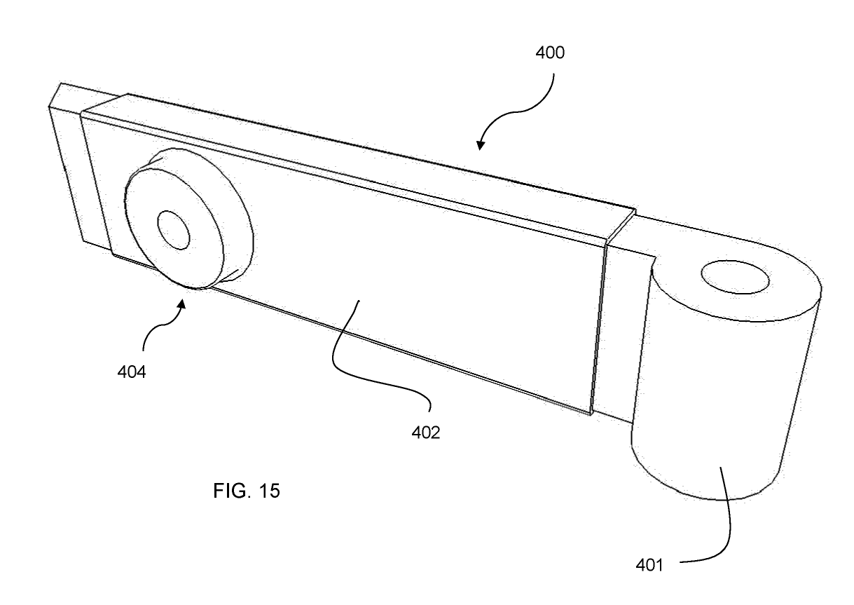

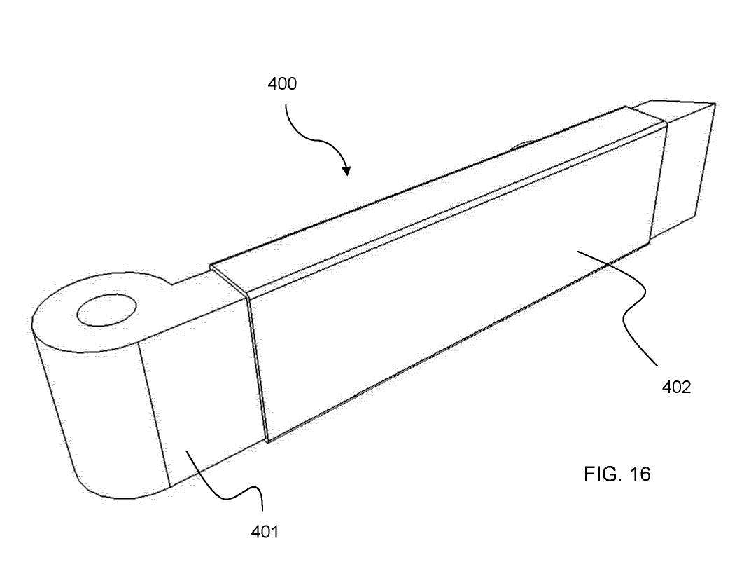

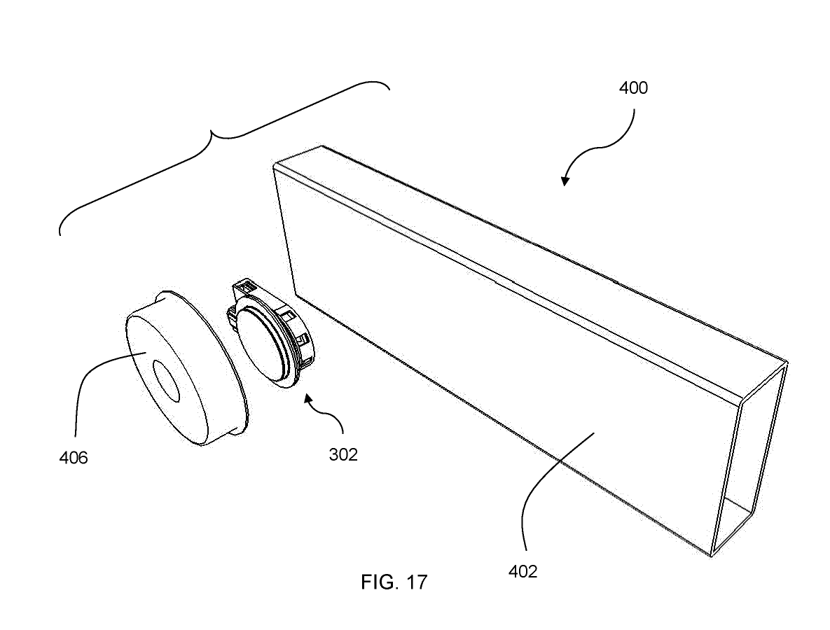

Referring to FIGS. 15-17, a fourth embodiment 400 of the present invention can be seen. The reminder device 400 includes means for providing at least one of a visual and an audible prompt that provides an audible prompt comprising a recorded audio message and/or sounds that prompt the user to check for the presence of an infant, baby, or toddler on board a vehicle. The means for providing at least one of a visual and an audible prompt comprises an audio module 302 supported by the support base, which in this embodiment is formed in part by a tubular sleeve 402.

As with the third embodiment 300, the audio module 302 is pressure activated and includes a pressure detecting portion 310. The support base is in the form of a sleeve 402 made of flexible material. The sleeve 402 is provided with a pocket 404. The audio module 302 is contained within the pocket 404. The sleeve 402 is adapted for placement around a door handle 401 of a vehicle to thereby attach the reminder device 400 to the door handle 401 of the vehicle and thereby attach the reminder device 400 to the vehicle interior. The door handle 401 has a back side that is engaged by the fingers of a person pulling on the door handle 401 to open the door. Accordingly, the pulling force or pressure is applied to the back side of the door handle when a person pulls on the door handle 401 to open the vehicle door. Preferably, the reminder device 400 is attached to the handle of the driver's side door.

The pocket 404 is positioned relative to the sleeve 402 so as to allow at least the pressure portion 310 of the audio module to be located on the back side of the vehicle door handle 401 such that the audio module 302 is automatically activated to play back the recorded audio message or sounds that prompt the user to check for the presence of an infant, baby, or toddler on board the vehicle when the user pulls the vehicle door handle 401 to open the vehicle door.

The sleeve 402 can be made of a rectangular sheet of flexible material that is rolled up so that its longitudinal edges are brought together and attached along their lengths to form a tubular sleeve. The flexible material for the sleeve may, for example, be made of fabrics made of natural or artificial fibers, natural or artificial leather, animal skin or hide, vinyl, rubber, elastic, TYVEC®, Lycra or Spandex, or other flexible polymeric or composite material. The longitudinal edges of the rolled-up sheet can be sewn together, adhesively attached, or heat fused to form the sleeve 402 that can slip over the automobile door handle 401. Alternatively, the longitudinal edges of the rolled-up sheet may each be provided with a portion of a slide fastener system (zipper) or a portion of a hook and loop fastener system (VELCRO®) so that the sleeve 402 can be placed around handles that are attached at both ends or may be more easily placed around handles with an enlarged portion near their free or swinging end. The audio module 302 can be sewn or otherwise enclosed in a pocket provided in or on the sleeve 402 so that the motion of pulling on the door handle 401 activates the audio module to play back a recording with a reminder to “check the baby.” In the illustrated example, the pocket 404 for holding the audio module 302 is provided on the outside of the sleeve 402. The pocket 404 is made of a top cover 406 that is attached or joined to the exterior of the sleeve 402, for example by sewing, heat fusion, or adhesive applied along the circular edge of the top cover 406.

It should be understood that the present invention is not limited to the specific embodiments described above, but includes any and all variations or modifications within the spirit and scope of the present invention as defined in the appended claims.

1. A reminder device for use in automotive applications in relation to an automobile or other vehicle, the reminder device comprising:
a support base adapted for attachment to one of a vehicle interior, a vehicle key, and a vehicle keyless remote access device; and
means for providing a visual and an audible prompt to a user to check for the presence of an infant, baby, or toddler on board the vehicle in order to prevent the infant, baby, or toddler from being left behind in a car or other vehicle, said means for providing at least one of a visual and an audible prompt being supported by said support base,
wherein audible prompt means provides an audible prompt and comprises a device selected from a bell, a rattle, and a chime attached to the support base, whereby the bell, rattle, or chime automatically generates sounds that direct the user's attention to the reminder device when the reminder device is attached to the door of an automobile and the door is opened.

2. The reminder device of claim 1, wherein the means for providing at least one of a visual and an audible prompt provides a visual prompt and comprises a readily visible written statement that reminds the user to check the vehicle for the presence of an infant, baby, or toddler.

3. The reminder device of claim 1, wherein the means for providing at least one of a visual and an audible prompt provides a visual prompt and comprises a transparent pocket for holding a picture of an infant, baby, or toddler.

4. (canceled)

5. The reminder device of claim 1, wherein the means for providing at least one of a visual and an audible prompt also provides a visual prompt and comprises a readily visible written statement that reminds the user to check the vehicle for the presence of an infant, baby, or toddler.

6. The reminder device of claim 5, wherein the means for providing at least one of a visual and an audible prompt further comprises a transparent pocket for holding a picture of an infant, baby, or toddler.

7. The reminder device of claim 6, wherein the support base comprises a rectangular sheet of flexible material having a hole in each corner.

8. The reminder device of claim 7, wherein the reminder device further comprises a pair of hooks provided with suction cups that engage respective holes at the top corners of the support base to attach the reminder device to an interior surface of a vehicle door.

9. The reminder device of claim 6, wherein the support base comprises a rectangular sheet of flexible material having a top edge and a first portion of a hook and loop fastener provided in a strip form on the backside of the sheet near the top edge of the sheet, and
wherein the reminder device further comprises a second portion of a hook and loop fastener provided in a strip form and adapted for attachment to an interior surface of a vehicle door using adhesive material applied to the backside of the second portion of a hook and loop fastener to thereby attach the reminder device to the interior surface of the vehicle door.

10. The reminder device of claim 3, wherein said support base is adapted for attachment to a key used for access or ignition of a vehicle, wherein the key has a head and a blade, and wherein said support base is adapted for attachment to the head of the key used for access or ignition of the vehicle.

11. The reminder device of claim 10, wherein the means for providing at least one of a visual and an audible prompt further comprises a readily visible written statement that reminds the user to check the vehicle for the presence of an infant, baby, or toddler.

12. The reminder device of claim 11, wherein said support base is adapted for attachment to the head of the key using adhesive material applied to one side of the support base near an edge of the support base such that the blade of the key is clear of said support base and the reminder device will not interfere with the normal operation of the key.

13. The reminder device of claim 12, wherein said support base is in the form of a rigid, transparent, rectangular, and flat plate of plastic or polymeric material.

14. The reminder device of claim 1, wherein the means for providing at least one of a visual and an audible prompt further provides an audible prompt comprising a recorded audio message or sounds that prompt the user to check for the presence of an infant, baby, or toddler on board the vehicle.

15. The reminder device of claim 14, wherein the means for providing at least one of a visual and an audible prompt provides an audible prompt and comprises an audio module supported by said support base, said audio module being adapted to store and playback at least one audio file containing the recorded audio message or sounds that prompt the user to check for the presence of an infant, baby, or toddler on board the vehicle.

16. The reminder device of claim 15, wherein said audio module comprises:
a speaker;
an audio chip with on-board memory for storing said audio file and communicating with said speaker so as to be capable of providing audio signals to said speaker for playback of the recorded audio message or sounds contained in the audio file;
battery for powering the audio module; and
pressure switch communicating with said audio chip such that the recorded audio message or sounds that prompt the user to check for the presence of an infant, baby, or toddler on board the vehicle are played back through the speaker when the pressure switch is pressed.

17. The reminder device of claim 16, wherein said audio module further comprises:
a housing containing said speaker, said audio chip, and said battery, wherein said pressure switch is located external to said housing.

18. The reminder device of claim 15, wherein said audio file contains a recorded audio message that prompts the user to check for the presence of an infant, baby, or toddler on board the vehicle.

19. The reminder device of claim 15, wherein said audio module is pressure activated and includes a pressure detecting portion, wherein said support base is in the form of a pocket made of flexible material, said pocket having a back side, said audio module being contained within said pocket, said pocket being adapted for attachment to a vehicle keyless remote access device having a backside and a door locking switch, said pocket being adapted for attachment to the backside of the vehicle keyless remote access device using adhesive material applied to the backside of said pocket to thereby attach the reminder device to the backside of the vehicle keyless remote access device at a location such that at least said pressure portion of said audio module is located behind the door locking switch of the vehicle keyless remote access device such that the audio module is automatically activated to play back the recorded audio message or sounds that prompt the user to check for the presence of an infant, baby, or toddler on board the vehicle when the user presses the door locking switch of the vehicle keyless remote access device.

20. The reminder device of claim 15, wherein said audio module is pressure activated and includes a pressure detecting portion, wherein said support base is in the form of a sleeve made of flexible material and being provided with a pocket, said audio module being contained within said pocket, said sleeve being adapted for placement around a door handle of a vehicle to thereby attach the reminder device to the door handle of the vehicle and thereby attach the reminder device to the vehicle interior, the door handle having a backside, said pocket being positioned relative to said sleeve so as to allow at least said pressure portion of said audio module to be located on the backside of the vehicle door handle such that the audio module is automatically activated to play back the recorded audio message or sounds that prompt the user to check for the presence of an infant, baby, or toddler on board the vehicle when the user pulls the vehicle door handle to open the vehicle door.
